(19) United States
(12) Patent Application Publication
(10) Pub. No.: US 2024/0324823 A1
(43) Pub. Date: Oct. 3, 2024

(54) SYSTEM AND METHOD FOR PROVIDING MEAL ORDER, PREPARATION AND DELIVERY SERVICE

(71) Applicant: REMY ROBOTICS SL, Barcelona (ES)

(72) Inventors: Egor Ivanov, Barcelona (ES); Manel TERRAZA FARRÉ, Barcelona (ES); Vasilii ARTEMEV, Barcelona (ES); Pablo CARRASCO ZANINI, Barcelona (ES); Andres Feli NAVAS ESCOBAR, Barcelona (ES); Min Gu KWON, Barcelona (ES); Matteo MENNA, Barcelona (ES); Aleksandr ANDREEV, Barcelona (ES); Iunus ZAITAEV, Barcelona (ES); John Alexander HUTT, Barcelona (ES)

(73) Assignee: REMY ROBOTICS SL, Barcelona (ES)

(21) Appl. No.: 18/695,247

(22) PCT Filed: Sep. 28, 2022
(86) PCT No.: PCT/EP2022/077066

§ 371 Date: Mar. 25, 2024

(30) Foreign Application Priority Data
Sep. 29, 2021 (NL) 2029276

(51) Int. Cl. A47J 44/00; B25J 11/00; B25J 15/10; B25J 19/02; G06K 7/14; G06Q 50/12

(52) U.S. Cl. CPC A47J 44/00; B25J 11/0045; B25J 15/106; B25J 19/023; G06K 7/1417; G06Q 50/12

(57) ABSTRACT

A system and method for providing meal order, preparation and delivery service includes an order receiving unit for receiving an order for a meal selected from a plurality of offered meals of different types, a meal storage and preservation unit for storing and preserving the meal before preparation, a meal preparation unit for preparing the meal, and an output part for outputting the meal prepared with the meal preparation unit. A container for containing the meal therein is configured such that the meal can be stored, preserved, prepared and dispensed by the meal storage and preservation unit, the meal preparation unit, the output part, respectively, while the meal is contained in the container. A robotic device includes a manipulator for moving the container is arranged so each of the meal storage and preservation unit, the meal preparation unit and the output part are within the operating range of the manipulator.

The present invention relates to a system for providing meal order, preparation and delivery service. Furthermore, present invention relates to a method for providing meal order, preparation and delivery service.

Today, meal order, preparation and delivery often runs through existing restaurants. An order for a meal may be placed by telephone or on-line with a restaurant, after which the restaurant processes the order. Typically, chefs in a restaurant's kitchen process orders on a first-come, first-served basis. However, meal preparation time can vary significantly from meal to meal. As a consequence, the delivery of relatively “easy” orders may take longer than is generally considered acceptable.

In addition, since home delivery meal orders are inherently not limited by a restaurant's seating capacity, kitchen delivery capacity is typically heavily utilized, particularly during peak times. Chefs are therefore under constant high pressure to deliver every meal at the correct delivery time, while every meal must be of the same high quality. Due to this pressure, meal quality and timeliness of delivery can get compromised.

Furthermore, customers are typically unwilling to pay restaurant prices for home-delivered meals, while the expenditure of restaurants is commonly high, not least because of the sitting capacity of restaurants.

Hence, in terms of operational efficiency, cost efficiency and quality assurance, existing restaurants are typically not optimized for meal order, preparation and delivery service.

Recently, delivery-only restaurants, also known as dark kitchens (or “virtual/cloud/ghost kitchens” etc.), have become more and more popular. These delivery-only restaurants have no storefront and no sitting capacity, so that operating costs are lower than that of traditional restaurants. However, apart from having no storefront and no sitting capacity, these dark kitchens are further operated like traditional restaurants. While cost efficiency may thus be somewhat increased, operational efficiency and quality assurance are typically not improved.

Furthermore, in an attempt to increase operational efficiency, parts of the meal preparation process are more or more automated using dedicated devices or systems. However, these devices or systems are typically configured to either (i) carry out only one task within the meal preparation process, as a result of which operational and cost efficiency are only slightly increased, or (ii) mimic the complete meal preparation process, which typically causes the process to be either slow or only suitable for preparing only one type of dish. Variety and flexibility in the types of dishes offered are thereby drastically reduced.

It is therefore an object of the present invention to provide a system and method for providing meal order, preparation and delivery service with improved operational and cost efficiency and improved quality assurance. Moreover, it is an object to provide a system and method for providing meal order, preparation and delivery service which is flexible in terms of the types of dishes offered.

The present invention provides thereto, according to a first aspect thereof, a system for providing meal order, preparation and delivery service according to claim 1. Specifically, the system comprises an order receiving unit configured to receive an order for a meal selected from a plurality of offered meals of different types, a meal storage and preservation unit configured to store and preserve the meal before preparation thereof, a meal preparation unit configured to prepare the meal, and an output part for outputting the meal prepared with the meal preparation unit thereto. Furthermore, the system comprises a container for containing the meal therein, configured such that the meal can be stored, preserved, prepared and dispensed by the meal storage and preservation unit, the meal preparation unit, the output part, respectively, while the meal is contained in the container. A robotic device is provided which comprises a manipulator configured to move the container, including a holding means configured to hold the container, the robotic device being arranged so that each of the meal storage and preservation unit, the meal preparation unit and the output part are within the operating range of the manipulator. The system further includes a control unit, comprising a processor communicatively coupled to the robotic device, and a non-transitory memory coupled to the processor, the memory storing data related to the order and the meal into a database and instructions executable by the processor to cause the processor to control the robotic device to successively remove the container from the meal storage and preservation unit, place the container into the meal preparation unit, remove the container from the meal preparation unit, and move the container to the output part.

A great benefit of this system is that ordered meals can be processed and cooked completely autonomously, i.e. without any human intervention. Consequently, no human staff is needed to process the orders and to prepare the meals. This reduces labor costs and guarantees a consistent quality of the meals prepared by the system. In particular, the container and the robotic device contribute significantly to the autonomy of the system. The container allows easy handling of the meal by the robotic device in each and every step of the meal preparation process. The robotic device is specifically arranged to hold and move the container from one unit in the system to the other. Moreover, the container may comprise any dish that is on offer. The system is thus not limited to carrying out only one task within the meal preparation process nor to mimicking the complete meal preparation process for one type of dish only. On the contrary, the system specifically allows autonomously preparing and delivering many types of dishes without needing to mimic traditional food cooking processes.

In addition, the container allows reducing food waste to a minimum. The system as a whole, including the container, allows achieving a high level of standardization, reducing deviations in meal quality and thereby improving overall customer satisfaction.

Preferably, the container constitutes a deliverable package ready for delivery to a customer. In this way, there is no need to package the meal after it is dispensed by the system. This contributes further to the autonomy of the system.

More preferably, the container comprises a receptacle covered with a transparent and microporous film which thermo-sealed onto edges of the receptacle. The film is configured to protect the meal from foreign contaminants throughout the life cycle of the container and to allow steam to escape during meal preparation, e.g. cooking. Preferably, the receptacle is made of a material that is designed to withstand storage and preservation at −40 degrees C. as well as cooking at high temperatures, preferably more than 200 degrees C.

In a preferred embodiment, the system further comprises a measuring means including a sensor configured to measure value of a parameter indicative of a quality of meal preparation after being prepared by the meal preparation unit, wherein the instructions are configured to cause the processor to control the measuring means to measure the parameter before the container is moved to the output part. In this way, the system is thus configured to check and control the quality of the meal preparation process. When the system measures a meal quality parameter value which deviates from a required value, the container containing may be re-processed by the system or rejected. The system is configured to perform this quality control fully autonomously. Preferably, the measuring means are configured to measure at least one of: temperature information about the temperature of the meal in the container, a color change and/or a shape change of the container, presence of stains on the container, damage of the container, weight information about the weight of the meal in the container. If, for instance, the weight information indicates a significant deviation from the weight range of the meal associated to the cooked meal which is contained in the code, the system may reject the container and re-start the process by picking a new container from the storage and preservation unit in accordance with the customers' order.

Preferably, the measuring means comprises at least one of: a thermal camera, a photo camera, a vision camera, and a scale. A thermal camera may measure the temperature information about the temperature of the meal, while a photo camera and a vision camera may measure the integrity of the container, such as its shape, its color, and the presence of stains and/or damage. The scale may measure the weight information about the weight of the meal.

In a preferred embodiment of the system, the data related to the order and the meal comprise a desired delivery time and place at which the meal is to be delivered to a customer and a meal preparation time for preparing the meal, and the instructions are configured to cause the processor to control the robotic device on the basis of the desired delivery time and place and the meal preparation time. The system thereby allows smart scheduling of operations within the system, such that the meal is delivered on time while the time between the end of the preparation (cooking) operation by the meal preparation unit and the delivery time is kept at an optimum, such that the meal preparation process is just finished when the meal is delivered. In other words, it allows taking into account that the cooking process may continue after the meal is removed from the meal preparation unit. For completeness' sake, it is noted that the delivery comprises remote delivery and on-site delivery, i.e., next or close to the system.

In a preferred embodiment, the container comprises on one of its outer surfaces a code and the system comprises a code reading means configured to read the code, wherein the code contains information about the meal comprising a meal reference identifying the meal inside the container, and wherein the data comprise the information about the meal. Accordingly, the system is able to identify each container and thereby trace each meal. In case of a queue of orders, the system is thus preferably configured to have full traceability of each order in the queue, knowing the specific required/assigned time for each order in each stage of the order and delivery process (order processing, meal preparing, outputting, and delivery) carried out by the system. Each order processed by the system, which may comprise one or multiple meals/dishes, each with specific meal preparation times, may individually be considered by the system in its scheduling process. Preferably, the system is configured to consider multiple variables, comprising at least one of: number of current orders in queue, expected total processing time per order (order processing, meal preparing, outputting, and delivery), real total processing time of the processed order, etc. Also, the system may preferably be configured to take into account the location of the customer, e.g. its home or work address, and an available number of delivery couriers, in order to accurately match the delivery time with the desired delivery time. In addition, due the system is being configured to have full traceability of each order, customers have continuous and updated information about the processing stage of their order. In this way, customers can follow their orders during each stage of the order and delivery process carried out by the system, before arriving at their delivery address. In this way, customer's expectations are managed and satisfied. Preferably, the system is thus configured to schedule orders and/or trace ordered meals fully autonomously. More preferably, the system is configured to schedule the orders according to the order that is most time-efficient and most optimized in terms of meeting customers' demands.

Preferably, the information about the meal further comprises at least one of: ingredients of the meal, specifics about any pre-preparation of the meal, comprising a date of pre-preparation and/or identity information of a chef who pre-prepared the meal, a supplier of ingredients, a total weight of the meal before being prepared by the meal preparation unit, and a meal storage and preservation temperature.

In a preferred embodiment, the system is further configured to register positional information about the position of the container in the meal storage and preservation unit and store the positional information in the memory. This allows knowing where the container is located in the meal storage and preservation unit.

Preferably, the system is configured to register positional information about the position of the container in the system and update the positional information in the memory. In this way, the system knows where the container is in the system.

More preferably, the system is configured to link the positional information to the meal reference. It enables the system to trace each of a plurality of ordered meals in the whole of the system. Specifically, it enables the system to place each of a plurality of meals, each contained in its own dedicated container, at a specific location in the meal storage and preservation unit and to retrieve the right meal, among the plurality of meals stored in the meal storage and preservation unit, from its respective specific location in the meal storage and preservation unit.

In a preferred embodiment of the system, the system further comprises a depth camera. On top of the stored positional information in the memory, the depth camera assists in finding the exact location of the container before it is picked up by the manipulator of the robotic device. More preferably, the depth camera is mounted on the manipulator near the holding means of the robotic device. The depth camera and the holding means are, so to speak, integrated with each other. This makes for a compact and structurally simplified system. With the depth camera on the manipulator near the holding means, it is as if the holding means are provided with eyes. Preferably, the depth camera is an RGB-D camera configured to acquire both color and depth information from objects to be imaged by the RGB-D camera.

Preferably, the code reading means comprises the depth camera, wherein the depth camera is configured to image the code. The code is thus read using the depth camera. The depth camera is thus configured to find the right container and assist in picking up the right container using the robotic device.

Preferably, the holding means comprise a gripper mechanism configured to grip an outer surface of the container so as to hold the container. The gripper mechanism may be a mechanical gripper, a vacuum gripper and/or a magnetic gripper or the like. The outer surface of the container may be smooth and flat and the gripper mechanism may be configured to grip the smooth and flat outer surface.

In an alternative or further preferred embodiment, the meal storage and preservation unit comprises a closing member configured to close an access opening of the meal storage and preservation unit, which is movable between a closed state, in which an inner space of the meal storage and preservation unit is closed from the environment, and an open state, in which the robot has access to the inner space of the meal storage and preservation unit, the processor is communicatively coupled to the meal storage and preservation unit, and the instructions are configured to cause the processor to control the meal storage and preservation unit to move to its open state before the meal is removed from the meal storage and preservation unit and to move to its closed state after the meal is removed from the meal storage and preservation unit.

It is noted that the meal storage and preservation unit, with or without closing member, may be configured to operate stand-alone at a constant meal storage and preservation temperature.

In a preferred embodiment, the processor is communicatively coupled to the meal storage and preservation unit, and the instructions are configured to cause the processor to control the meal storage and preservation unit to store and preserve the meal at a predetermined meal storage and preservation temperature. This control of the meal storage and preservation unit allows controlling and thus varying the temperature at which the meal in the container is to be stored and preserved. A benefit thereof is that the system is flexible in terms of types of dishes that it can process, since different dishes require different storage and preservation temperatures. Moreover, the processor being communicatively coupled to the meal storage and preservation unit enables monitoring the temperature of inside the meal storage and preservation unit. This allows ensuring the quality of the meal. If the temperature inside the meal storage and preservation unit rises, the processor will know and may correct this in a timely manner or dispose any spoiled dishes, thereby avoiding potential food contamination.

In an alternative or further preferred embodiment, the meal preparation unit comprises a closing member configured to close an access opening of the meal preparation unit, which is movable between a closed state, in which an inner space of the meal preparation unit is closed from the environment, and an open state, in which the robot has access to the inner space of the meal preparation unit, the processor is communicatively coupled to the meal preparation unit, and the instructions are configured to cause the processor to control the meal preparation unit to move to its open state before the meal is placed into the meal preparation unit, to move to its closed state after the meal is placed into the meal preparation unit, and to move to its open state again after the meal has been prepared by the meal preparation unit. After the meal has been removed from the meal preparation unit, the instructions may cause the processor to control the meal preparation unit to move to its closed state again.

It is noted that meal preparation unit, with or without closing member, may be configured to operate stand-alone, whether or not at a constant meal preparation temperature.

In a preferred embodiment, the processor is communicatively coupled to the meal preparation unit, and the instructions are configured to cause the processor to control the meal preparation unit to prepare the meal according to a customized preparation program, including variable preparation parameters, including at least one of a preparation technology to be used (e.g. hot air or microwave), a preparation time, a preparation temperature, a preparation intensity (e.g. a power setting for cooking using microwaves) and a weight of the meal. As an alternative or in addition to the weight of the meal, the variable preparation parameters may include a density and/or a viscosity of the meal. This control of the meal preparation unit thus allows varying the preparation parameters and thereby controlling the preparation conditions, such as temperature, at which the meal in the container is to be prepared. A benefit thereof is that the system is flexible in terms of types of dishes, and/or size and/or weight of each dish that it can process, as different types of dishes or same-type dishes of different size or weight require different preparation conditions.

The control unit being able to control each of the robotic devices, the meal storage and preservation unit and the meal preparation unit through the processor allows machine-to-machine (M2M) communication between the robotic device, the meal storage and preservation unit and the meal preparation unit. Operational efficiency is thereby significantly improved compared to human-operated kitchen, while flexibility in handling different dish-types is not compromised. Specifically, the productivity of the system is enhanced due to higher processing speeds that can be achieved by the robots, i.e. the robotic device, the meal storage and preservation unit and the meal preparation unit. Since no human intervention is needed, the controllability of the meal storage and preservation unit and the meal preparation unit as well as the control of these units by the control unit on top of the control of the robotic device contributes significantly to the autonomy of the system.

In a preferred embodiment, the system may be a modular system of robotic devices, meal storage and preservation units and meal preparation units. That is, the system may start with an initial capacity determined by an initial number of robotic devices, meal storage and preservation units and meal preparation units. If the demand increases the capacity can be increased by adding robotic devices, meal storage and preservation units and/or meal preparation units to the system. Preferably, the robotic devices are configured to scan their environment and thereby map the position of the meal storage and preservation units and meal preparation units and/or of other robotic devices, so that the robotic devices know where each of the units is positioned in the modular system. Consequently, the addition and/or removal of units and their positions in the system can be autonomously obtained by the systems. This allows for easy and fast expansion of the system, while not compromising the reliability of the system.

According to a second aspect thereof, the present invention provides a method for providing meal order, preparation and delivery service. The method comprises, at a first location, pre-preparing a meal in a first preparation step, putting the meal in a container after pre-preparing the meal. Afterwards, the container is transferred to a second location remote from the first location. The method further comprises, at the second location, providing a robotic system for autonomously preparing the meal, comprising a robotic device having a manipulator, including a holding means configured to hold the container: placing the container in a meal storage and preservation unit configured to store and preserve the meal in the container: receiving an order for the meal, and successively, in response to the order, by the robotic device:
removing the container from the meal storage and preservation unit;
placing the container into a meal preparation unit configured to prepare the meal;
removing the container from the meal preparation unit when the meal preparation unit has finished preparing; and
outputting the container containing the meal prepared with the meal preparation unit.

Finally, the dispensed container containing the meal is delivered from the second location to a customer that placed the order.

In a preferred embodiment, the method further comprises, by the robotic system, measuring a parameter indicative of a quality of meal preparation after the meal preparation unit has finished preparing the meal and before the step of outputting the container. In this way, the quality of the meal preparation process of thus the quality of the meal inside the container can be checked.

In a further preferred embodiment, the method further comprises, after the meal preparation unit has finished preparing the meal, by the robotic system, a least one of the following steps: measuring a temperature of the meal using a thermal camera; determining an integrity of the container, including determining a color change and/or a shape change of the container, presence of stains on the container and/or damage of the container, using a photo camera and/or a vision camera; and measuring a weight of the container using a scale.

In a preferred embodiment, the method further comprises at the first location: applying a code to the container, the code containing information about the meal; and at the second location; by the robotic system, reading the information from the code using a code reading means and storing the information in a memory, wherein the information about the meal comprises a meal reference for identifying the meal inside the container, and wherein the step of reading the information from the code and storing the information in a memory comprises identifying the meal inside the container using the meal reference.

Preferably, the information about the meal further comprises at least one of: ingredients of the meal, specifics about any pre-preparation of the meal, comprising a date of pre-preparation and/or identity information of a chef who pre-prepared the meal, a supplier of ingredients, a total weight of the meal before being prepared by the meal preparation unit and a weight range within which the weight of the meal has to be after preparation in order to be accepted, and a meal storage and preservation temperature.

In a preferred embodiment, the method further comprises, by the robotic system, registering positional information about the position of the container in the meal storage and preservation unit and storing the positional information in the memory.

Preferably, the method further comprises, by the robotic system, linking the positional information to the meal reference.

In a further preferred embodiment, the method further comprises, before the container is removed from the meal storage and preservation unit, locating, by the robotic system, the container in the meal storage and preservation unit on the basis of the meal reference and the positional information linked thereto.

Preferably, the method further comprises, by the robotic system, locating the container in the meal storage and preservation unit using a depth camera. Preferably, the depth camera is mounted on the manipulator near the holding means of the robotic device. The depth camera and the holding means are, so to speak, integrated with each other. This makes for a compact and structurally simplified system. With the depth camera on the manipulator near the holding means, it is as if the holding means are provided with eyes. Preferably, the depth camera is an RGB-D camera configured to acquire both color and depth information from objects to be imaged by the RGB-D camera.

In a preferred embodiment, the information about the meal is read from the code using the depth camera.

In a preferred embodiment, the method further comprises, by the robotic system, measuring a parameter indicative of a quality of meal preparation after the meal preparation unit has finished preparing the meal and before the step of outputting the container.

In a further preferred embodiment, the method further comprises, after the meal preparation unit has finished preparing the meal, by the robotic system, a least one of the following steps: measuring a temperature of the meal using a thermal camera; determining an integrity of the container, including a shape and/or a color of the container, using a photo camera and/or a vision camera; and measuring a weight of the container using a scale.

For the particular advantages and technical effects of the inventive method and its preferred embodiments as described herein, reference is made to the description above regarding the system counterparts of the method and its preferred embodiments. The inventive method and its preferred embodiments provide at least the same particular advantages and technical effects.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary and are intended to provide an overview or framework to understand the nature and character of the claims.

The accompanying drawings are included to provide a further understanding and are incorporated in and constitute a part of this specification, wherein:

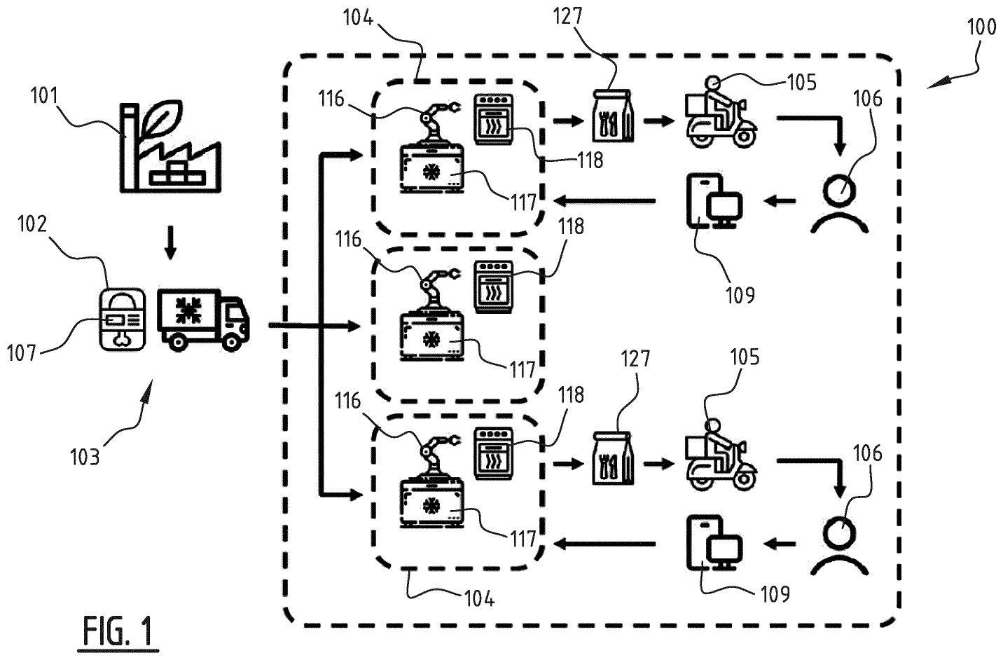

FIG. 1 shows a schematic diagram of a preferred embodiment of the method according to the present invention;

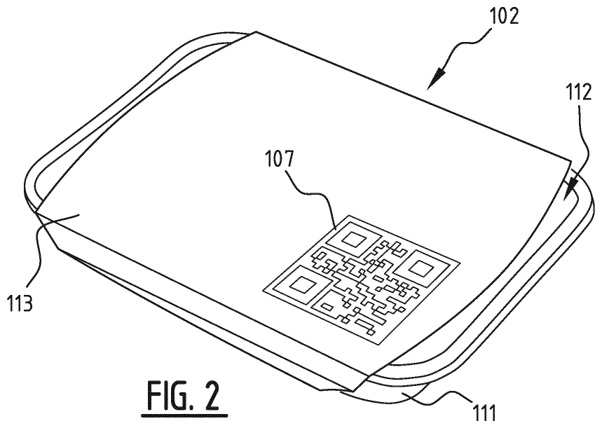

FIG. 2 shows a perspective view of a preferred embodiment of a container as part of a preferred embodiment of the system according to the present invention:

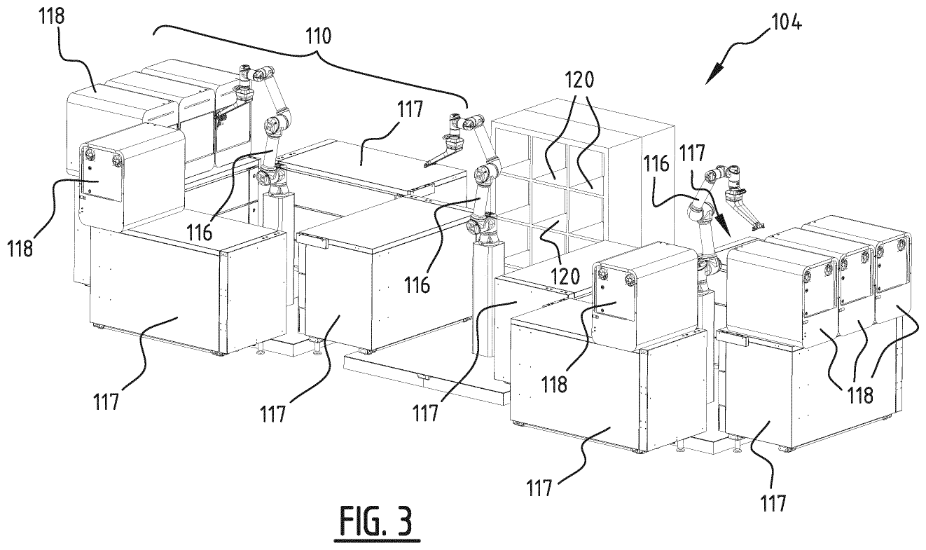

FIG. 3 shows a perspective view of a preferred embodiment of the system according to the present invention;

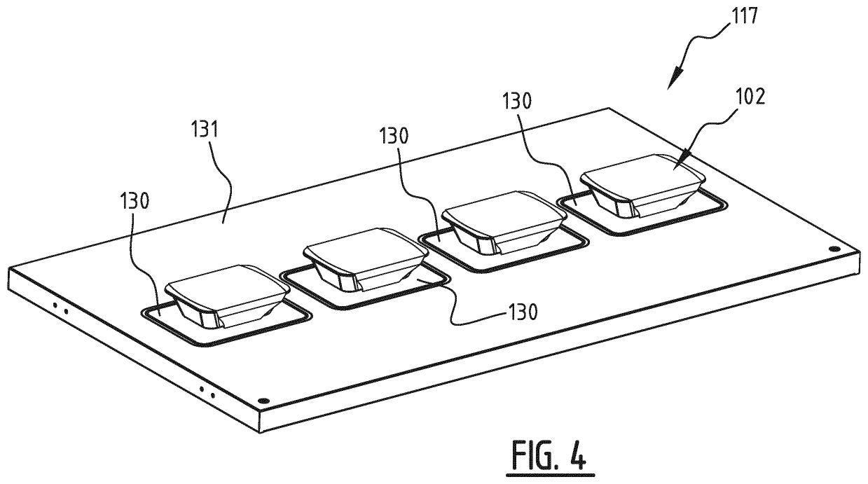

FIG. 4 shows a close-up view of an element of the system shown in FIG. 3:

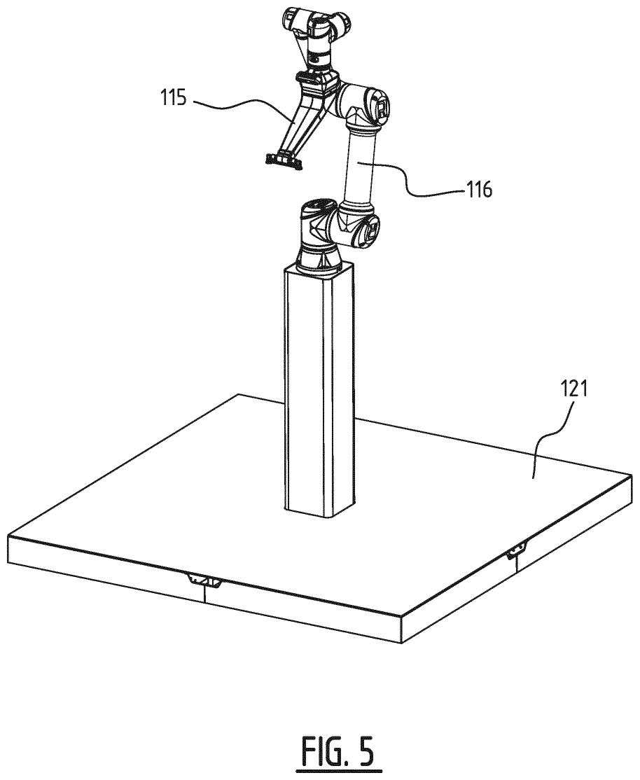

FIG. 5 shows a close-up view of another element of the system shown in FIG. 3;

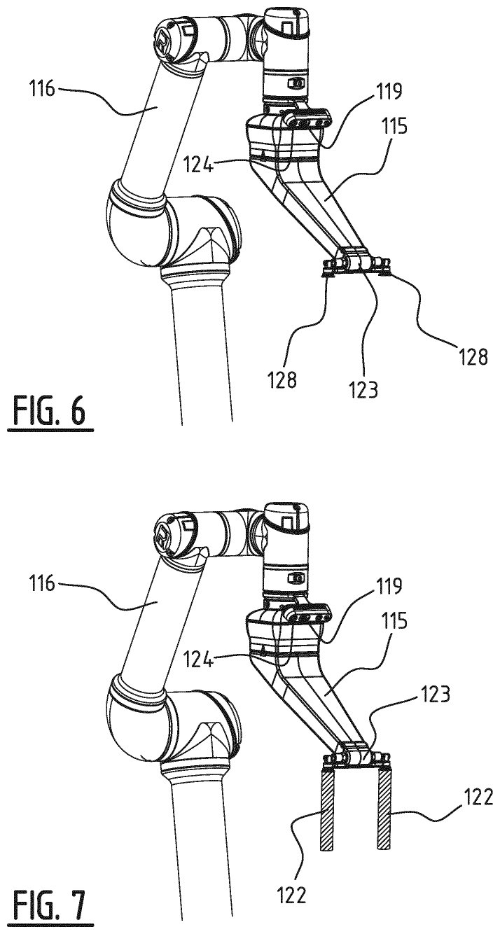

FIG. 6 shows a close-up view of a part of the element shown in FIG. 5; and

FIG. 7 shows an alternative embodiment of the part shown in FIG. 6.

FIG. 1 shows a schematic representation network 100 for providing meal order, preparation and delivery service. Network 100 comprises one or more central kitchens 101, also referred to as culinary hubs, producing pre-prepared meal packages 102, i.e. containers containing pre-cooked meals. It is noted that the term “pre-prepared” comprises meals that are fully cooked, partially cooked, i.e. neither completely cooked/prepared nor raw, and meal that are not cooked. The level of pre-preparation varies from dish to dish (i.e. meal type). A distribution system 103 is provided for transporting the packages 102 to several robotic kitchens 104 on demand without breaking the so called “cold chain”, i.e. while keeping the packages 102 at their prescribed preservation temperature, e.g. at room temperature, 4 degrees C. or −18 degrees C. The robotic kitchens 104, also referred to as autonomous kitchens or autonomous nodes, are responsible for converting an inventory of individual meal packages 102 into finished meals in response to delivery orders and without any human intervention. A network of delivery couriers 105 is provided to deliver the finished meals in their meal package 102 to an ordering customer 106.

At the same time, FIG. 1 is a schematic representation of a method of providing meal order, preparation and delivery service. Specifically, the method includes pre-preparing meals at one or more central kitchens 101, bringing the temperature of the pre-prepared meals to their prescribed preservation temperature, e.g. freezing the pre-prepared meals using an individual quick freezing (IQF) technique, and packaging the pre-prepared meals in dedicated containers 102. Subsequently, the containers/packages 102 are each provided with a code 107, e.g. a QR-code, containing information about the content of the package 102, i.e. the meal, and e.g. the pre-preparation date and time as well specifics about preservation and preparation of pre-prepared meal. Each package 102 is subsequently transported to a robotic kitchen 104 remote from the central kitchen 101. At the location of the robotic kitchen 104, the code 107 of the package 102 is scanned, so that the meal therein is identified. Then, the package 102 containing the meal is stored in a freezer 117 before it is prepared in response to a digital order received from a customer 106. Freezer 117 may be configured/programmed to act as a refrigerator and/or a climate cabinet, thereby allowing e.g. 3 temperature states at which the packages 102 can be stored: (i) freezing temperature (e.g. −18 or −40 degrees C.), (ii) cooling temperature (e.g. 4 degrees C.) and (iii) room/ambient temperature (e.g. 20 or 25 degrees C.).

Typically, the customer 106 may use a personal computer or a mobile device 109 to place the order. The order may be placed remotely by a mobile device, such as a mobile phone, or through an in-house kiosk, just to name of few examples. In either case, a customized software application may be provided through which the customer 106 can place its order. After the order is placed, the robotic kitchen 104 will autonomously process the order and prepare the meal in accordance with the order specifics, such as meal type, delivery time and delivery place, and with the meal preparation specifics known by the system, preferably using the code 107 on the package 102. After the robotic kitchen 104 has prepared the ordered meal, the meal will be picked up by delivery courier 105 to deliver the order meal to the customer 106. A node specialist, i.e. a person at the location of the robotic kitchen 104, may assist the courier 105 by packing the package 102 in a bag and handing the bag over to the courier 105.

As such, the robotic kitchen 104, which can be seen as an autonomous node in the network 100, makes use of packages 102 of pre-prepared meals. These packages 102, one of which is shown in FIG. 2, allow easy handling of the meal by the robotic kitchen 104 in each and every step of the meal preparation process carried out by the robotic kitchen 104. Specifically, each meal package 102 is uniquely designed to be cooked according to a specific process which ensures a high quality of the meal ordered by the customer 106.

Specifically, each meal package 102 has on its outside a QR-code 107 which provides an individual meal reference for the meal inside the package 102, which is designed to be stored, processed, and robotically cooked in the robotic kitchen 104. The meals in packages 102 may be blast frozen using an IQF technique in the central kitchen 101 after the pre-preparation process, which ensures that meal keeps its culinary and nutritional properties. However, depending on the preservation requirements of the meal, alternative techniques other than IQF may be used as well.

As discussed, each meal package is transported to a robotic kitchen 104, where it is stored and subsequently cooked robotically by robotic equipment 110. Accordingly, most of the meal recipes used are specially designed to be cooked in two steps: first, in the central kitchen 101 (pre-preparing), and secondly in the robotic kitchen 104, where each meal package is robotically cooked after a customer 106 places an order. Specifically, the recipes are created considering the full process, even the specific time meal packages 102 are in the delivery stage, i.e . . . the stage after preparation and before the actual delivery to the customer. As the meal packages 102 are sealed, a meal inside a meal package 102 is sealed from the outside environment, so that the cooking process continues to certain degree during the delivery process, i.e., the process after preparation and before the actual delivery to the customer. In other words, the rate at which e.g. the temperature and relative humidity inside the package reach equilibrium with the ambient temperature and relative humidity is slowed down due to the sealing.

Specifically, the meal packages 102 comprise three elements: a tray 111, a bio-plastic film 112 covering the tray 111, and a sleeve 113 around the tray 111 and the film 112. These three elements are designed to withstand and support the full process, from high cooking temperatures to deep-frozen temperatures (i.e. −40 degrees C.), as well as to maintain all food properties and flavors, so that the meal arrives in perfect condition to the customer 106. The sleeve 113 surrounds the tray 111. The QR code 107 is printed at the top of the sleeve 113. Alternatively, the QR-code may be provided at a different position on the outer surface of the package 102, as long as it can be read from the outside. Also, as an alternative to the package shown in FIG. 2, the packages 102 may comprise a tray and a lid instead of a bio-plastic film.

The meal packages 102 are designed to be gripped by grippers 115 of a robotic manipulator 116 in the robotic kitchen 104, so that the meal packages 102 can be held and moved by the robotic manipulator 116 from one robotic device (e.g. a smart freezer) in the robotic kitchen 104 to another (e.g. a smart oven). Due to the QR-code 107 on the sleeve 113, the robotic kitchen 104 is able to identify and trace the each meal package. Specifically, the QR-code 107 gives access to a meal reference, a date of pre-preparation, ingredients, procurement information (date, supplier, etc.), information about the chefs who took part in pre-preparing the meals, a weight of the food before cooking and the weight ranges for after cooking states (which are essential in controlling the quality of the robotic cooking process carried out by the robotic kitchen 104), and preservation temperatures, etc.

The tray 111 is specifically adapted to the size of each type of meal. In turn, the robotic kitchen 104 is capable to manipulate and handle trays 111 of different sizes/shapes. The sealed film 112 on top of the tray 111 allows protecting the meal from foreign contaminants throughout the life cycle of the package 102. Furthermore, as discussed above, it keeps the meal hot, which at the same time allows continuing the cooking process while it is being transported from the kitchen 104 to a customer until the meal is finally ready. Moreover, the film 112 allows to open the tray 111 by the customer 106 and to ventilate to a certain degree while preserve the culinary properties of the meal, such as flavor and freshness. At the same time, it is designed to keep the right temperature during the delivery process. Specifically, the recipes take into account the effects of the sealed film 112 on the meal during the robotic cooking process carried out by the robotic kitchen 104.

Specifically, the package 102 is designed for delivery. As the recipes and processes are designed to reduce robot cooking time at the robotic kitchen 104, cooking times are short, thereby reducing the total delivery time to the customer 106. The two-stages preparation approach, i.e. the pre-preparation in the central kitchen 101 and the robotic cooking in the robotic kitchen 104, allows to reduce food waste to minimum, as no food is spilled in the process of cooking. Moreover, using just one package 102 for each particular meal allows reducing packaging waste when compared to restaurants, which prepare on-delivery meals by unpacking meal components from their packaging and packing finished meals in dedicated packages, thereby throwing away the packaging of the meal components.

Importantly, a high level of standardization can be obtained, reducing deviations from agreed quality, and ultimately enhancing meal quality for the customer 106.

A preferred embodiment of the robotic kitchen 104 is shown in FIG. 3. The robotic kitchen 104 is fully autonomous and configured for storing and managing inventory of pre-prepared meal packages 102. Moreover, the robotic kitchen 101 is configured to autonomously prepare ordered meals on-demand, including scheduling operations of the robotic devices in the robotic kitchen 104 on the basis of a queue of orders, cooking of the meals according to the schedule, checking and controlling the quality of the cooked meals, and bundling the meal and supplementary items (e.g. beverages, cutlery, sauces). These functions are each designed to be carried out fully autonomously, which means no human staff is required in the robotic kitchen 104 on a permanent basis during normal operation.

In order to carry out its main functions, the robotic kitchen 104 comprises smart refrigerators and/or freezers 117, smart cooking equipment, such as smart ovens 118, one or more robotic devices comprising manipulators 116 including end-of-arm tooling, such as grippers 115, one or more quality control devices, such as a thermal camera 119, smart output shelves 120 and one or more control units. Each of these elements is discussed below.

The smart freezers 117 are configured store the meal packages 102 at e.g. −18 degrees C. or at any temperature at which the meal needs to be stored and preserved. They comprise drawers, which can automatically open and close using a smart mechatronics module. The smart cooking equipment is comprised of high-speed combi-ovens 118 offering a mixture of high power microwave, convection and impingement cooking. The settings are controlled by the control unit. Also, the ovens 118 can automatically open and close using a smart mechatronics module. Furthermore, the ovens 118 are equipped with inverter microwave. Optionally, the ovens 118 may be equipped with solid state RF microwave technology.

The robotic manipulator 116 is of the articulated type and is configured to move the meal packages 102 in six degrees of freedom. Reference is made to FIGS. 4-6. The manipulator 116 is mounted on a base structure 121 and has a parallel active gripper 115 fitted with custom vacuum suction cups 128 or custom fingertips 122 and a swiveling joint 123. Due the arrangement of the custom cups 128 or custom fingertips 122 and the swiveling joint 123 the package 102 can swing once grabbed, which allows grabbing a package 102 from the top and then placing it horizontally into a deep cavity such as the interior space of the oven 118 of the robotic kitchen 104. The robotic manipulator 116 and in particular the gripper 115 are specifically configured to also pick up, move and place other types of containers/packages, i.e. other than meal packages 102, such as pouches or cans, et cetera. This way, the robotic kitchen 104 is very flexible in terms of types of items it can handle.

At the proximal end of the gripper 115 an RGB-D depth camera 124 is provided which is used for mapping the positions of the equipment 110 in the robotic kitchen 104 and for locating the meal packages 102 when needed, e.g. when removal of the package 102 from the freezer 117 or the oven 118 is needed. As meal quality control devices, thermal cameras 119 are provided to check temperature distribution of the meal package 102 after cooking in the oven 118. In addition, cameras 124 on board of the robotic manipulator 116 are used for performing a visual inspection of the package 102 to look for stains and other types of damage. In addition, weighing stations 130 are integrated in the top plate 131 of one or more refrigerators/freezers 117 for weighing the package 102 containing the meal. In this way, the weight of the meal after preparation in the oven 118 can be measured, which is indicative of the quality of preparation of the meal in the oven 118 and thus of the quality of meal preparation.

Slotted output shelves 120 (see FIG. 3) are provided for grouping the ordered meals, including supplementary items, such as sauces and cutlery etc. In particular, the output shelves 120 comprise smart light indicators configured to inform delivery couriers 105 or a node specialist (as discussed above) of the status of the ordered meal.

The robotic manipulators 116 are able to recognize each meal package 102 in the robotic kitchen 104 by reading the QR-code 107 whicheach meal package 102 has. The meal packages 102 are subsequently stored in the specially designed drawer freezers 117 which are autonomously opened and closed by the control unit when required, e.g. for stock scanning, stock regrouping, etc. Additionally, the freezers/fridges 117 have temperature sensors connected to the robotic kitchen system 104, providing full continuous traceability of the temperature inside the freezers/fridges 117. Once an order is received and accepted by the robotic kitchen 104, the robotic manipulators 116 installed along the robotic kitchen 104 autonomously pick up each meal package 102 with the specifically developed grippers 115 and handle it through the robotic kitchen 104, i.e. move it from the freezers/fridges 117 to the ovens 118. The robotic manipulators 116 are able to perform all manipulations with the meal packages 102. Also, supplementary objects, e.g. napkins, may be grabbed and moved by the robotic manipulators 116 thanks to the detection and recognition of the objects through computer vision. Alternatively, the supplementary objects may be provided with a code, by means of which they can be detected by the robotic manipulators 116. Typically, for cutlery and napkins no code is needed, as through computer vision, the robotic manipulators 116 are able to detect them and add them in case the customers' order requires it. For other items, such as bags, a code (where a code is any differentiation element-a colour dot, a specific label provided by an external supplier, but not necessary a QR code) on the bag is typically useful, so that the robot can easily identify the bag.

As a consequence of the integration of the robotic manipulators 116 with the freezers 117, the robotic kitchen 104 is configured to autonomously perform stock counting, that is: the robotic kitchen 104 keeps permanently updated stock levels of each meal type, as well as the exact locations of all meal packages 102. This is possible thanks to the scanning performed by the robotic manipulators 116 to identify each of the meal packages 102. Accordingly, when a new order is processed by the robotic kitchen 104, it knows exactly where each meal package 102 is located, so the robotic manipulators 116 can pick it up and handle it. In addition, the integration of the robotic manipulators 116 with the freezers 117 allows the robotic kitchen 104 to carry out an auto-refilling procedure. Meal packages 102 can be delivered to multiple robotic kitchens 104 from the central kitchen 101 and be stored randomly inside the freezers 117 (without any specific order between the meal packages 102) by humans. By scanning each meal package 102 individually, the robotic manipulators 116 are able to autonomously group the meal packages 102 by meal type, storing all available meal packages 102 within the robotic kitchen 104 in the most efficient way, e.g. by production date. Hence, the people in charge of stocking-up the robotic kitchens 104 do not need to place meal packages 102 in any specific order within the robotic kitchens freezers 117, as this process is autonomously performed by the robotic manipulators 116.

When an order is processed, the robotic manipulators 116 individually handle each meal package 102 associated with the order and place them in the specifically designed ovens 118. The robotic kitchen 104 autonomously controls each oven 118, including the opening and closing mechanism of the oven 118, and selecting the cooking program. Specifically, the robotic kitchen 104 is configured to select a predefined cooking program in accordance with specific cooking parameters associated with each meal package 102, such as meal type, weight of the meal package, expected delivery time for the order, production batch, etc. The cooking process may be individually tailored for each package 102, inter alia depending on the weight of the package 102 and the meal specifics, e.g. the initial recipe. The ovens 118 thereby apply a specific individual amount of power and/or heat depending on calculations of the robotic kitchen 104 on the basis of a prescribed cooking process for the meal. The robotic kitchen 104 further optimizes all the cooking processes in the order queue, comprising scheduling all orders to cook within the quickest and most optimized order. i.e. so that each desired delivery time is met, while the time between the end of the cooking process by the oven 118 and the delivery time is optimal. Once the meals in packages 102 are cooked, the robotic manipulators 116 perform quality control checks of the cooked food based on the smart sensors of e.g. thermal camera 119. If the quality control checks are not successfully passed, the whole cooking process for the ordered meal might start over, if the quality issue requires to cook a new dish Once the meal packages 102 have been robotically cooked, they are placed by the robotic manipulators 116 on the output shelves 120.

The robotic manipulators 116, using their robotics arms with customized grippers 115, place all elements of an order, including meal packages 102 and supplementary items, such as cutlery, sauces, bags, etc. on the assigned output shelves 120. Specifically, the robotic manipulators 116 pick up the meal packages 102 from the ovens 118, once they have been robotically cooked and successfully passed the quality control check, and place them one-by-one on the output shelf 120 that is assigned to the ordered meal. If an order includes cutlery, sauces, or any other item which does not need to be cooked, e.g. beverages or salads, the robotic manipulators 116 will handle these items from their associated storage equipment 117 and will place them directly on the same output shelf 120 as the ordered meal. Quality control checks are also performed for the supplementary items, including checking temperatures, sizes, weight, and physical aspects if required. The robotic kitchen 104 uses each of the output shelves 120 as an individual pick-up area for each order. In particular, the robotic kitchen 104 assigns an individual output shelf 120 to each order, once the order has been accepted. This process is performed autonomously by the robotic kitchen 104, assigning the most efficient individual output shelf 120 considering all other orders in the queue, as well as predicted incoming orders. Hence, all meal packages 102 related to an order, as well as any other associated supplementary items, are placed by the robotic manipulators 116 into the assigned output shelf 120.

Finally, a delivery courier 105 or node specialist, who is directed by customized software, will take all the elements associated with the order from the assigned output shelf 120, including meal packages 102 and supplementary items if applicable. Due to customized software integrated into the robotic kitchen 104, a delivery courier 105 knows when all elements associated with an order are placed on the assigned output shelf 120 (also a shelf light additionally indicates the readiness of the order status). A delivery courier 105 therefore cannot take out incomplete orders from the output shelves 120. Once all elements associated with the order are on the assigned output shelf 120, the delivery courier 105 will take all elements from the shelf 120 and place them into a delivery bag 127. The delivery courier will finally deliver the order to the customer 106. Alternatively, delivery courier 105 may be the customer 106 itself, so that the system 100 provides for self-pickup, and/or the system 100 may be located in or close to a dine-in facility such that the customer can choose to eat its ordered meal in said facility

As discussed above, while the robotic kitchen 104 is specifically configured to process packaged meals, it is not limited thereto. Robotic kitchen 104 able to process and handle other items, such as cutlery, sauces, or any other item which does not need to be cooked, e.g. beverages or salads. A customer can thus order multiple types of items, like in any conventional restaurants, and the order can be entirely processed by the robotic kitchen 104. This makes robotic kitchen 104 highly autonomous.

Thanks to computer vision, the robotic manipulators 116 can easily adapt to different kitchen layouts. A specific spatial arrangement of ovens 118 or freezers 117 is therefore not needed. The robots 116 are able to identify all elements in the kitchen 104, that is ovens 118, freezers 117, packages 102, etc. and autonomously interact with them.

The drawings are illustrative of selected aspects of the present disclosure, and together with the description serve to explain principles and operation of methods, products, and systems embraced by the present disclosure.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

1. A system for providing meal order, preparation and delivery service, comprising:
an order receiving unit configured to receive an order for a meal selected from a plurality of offered meals of different types;
a meal storage and preservation unit configured to store and preserve the meal before preparation thereof;
a meal preparation unit configured to prepare the meal;
an output part for outputting the meal prepared with the meal preparation unit thereto,
a container for containing the meal therein, configured such that the meal can be stored, preserved, prepared and dispensed by the meal storage and preservation unit, the meal preparation unit, the output part, respectively, while the meal is contained in the container;
a robotic device comprising a manipulator configured to move the container, including a holding means configured to hold the container, the robotic device being arranged so that each of the meal storage and preservation unit, the meal preparation unit and the output part are within the operating range of the manipulator; and
a control unit, comprising:
a processor communicatively coupled to the robotic device; and
a non-transitory memory coupled to the processor, the memory storing data related to the order and the meal into a database and instructions executable by the processor to cause the processor to control the robotic device to successively:
remove the container from the meal storage and preservation unit;
place the container into the meal preparation unit;
remove the container from the meal preparation unit; and
move the container to the output part.

2. The system according to claim 1, further comprising a measuring means including a sensor configured to measure a parameter indicative of a quality of meal preparation after being prepared by the meal preparation unit, wherein the instructions are configured to cause the processor to control the measuring means to measure the parameter before the container is moved to the output part.

3. The system according to claim 2, wherein the measuring means comprises at least one of: a thermal camera, a photo camera, a vision camera, and a scale.

4. The system according to claim 1, wherein the data related to the order and the meal comprise a desired delivery time and place at which the meal is to be delivered to a customer and a meal preparation time for preparing the meal, and wherein the instructions are configured to cause the processor to control the robotic device on the basis of the desired delivery time and place add the meal preparation time.

5. The system according to claim 1, wherein the container comprises on one of its outer surfaces a code and the system comprises a code reading means configured to read the code, wherein the code contains information about the meal comprising a meal reference identifying the meal inside the container, and wherein the data comprise the information about the meal.

6. The system according to claim 5, wherein the information about the meal further comprises at least one of: ingredients of the meal, specifics about any pre-preparation of the meal, comprising a date of pre-preparation and/or identity information of a chef who pre-prepared the meal, a supplier of ingredients, a total weight of the meal before being prepared by the meal preparation unit, and a meal storage and preservation temperature.

7. The system according to claim 1, wherein the system is further configured to register positional information about the position of the container in the meal storage and preservation unit and store the positional information in the memory.

8. The system according to claim 1, further comprising a depth camera mounted on the manipulator near the holding means of the robotic device.

9. The system according to claim 8, wherein the code reading means comprises the depth camera, wherein the depth camera is configured to image the code.

10. The system according to claim 1, wherein the holding means comprise a gripper mechanism configured to grip an outer surface of the container so as to hold the container.

11. The system according to claim 1,
wherein the meal storage and preservation unit comprises a closing member configured to close an access opening of the meal storage and preservation unit, which is movable between a closed state, in which an inner space of the meal storage and preservation unit is closed from the environment, and an open state, in which the robot has access to the inner space of the meal storage and preservation unit,
wherein the processor is communicatively coupled to the meal storage and preservation unit, and
wherein the instructions are configured to cause the processor to control the meal storage and preservation unit to move to its open state before the meal is removed from the meal storage and preservation unit and to move to its closed state after the meal is removed from the meal storage and preservation unit.

12. The system according to claim 1, wherein the processor is communicatively coupled to the meal storage and preservation unit, and wherein the instructions are configured to cause the processor to control the meal storage and preservation unit to store and preserve the meal at a predetermined meal storage and preservation temperature.

13. The system according to claim 1,
wherein the meal preparation unit comprises a closing member configured to close an access opening of the meal preparation unit, which is movable between a closed state, in which an inner space of the meal preparation unit is closed from the environment, and an open state, in which the robot has access to the inner space of the meal preparation unit,
wherein the processor is communicatively coupled to the meal preparation unit, and
wherein the instructions are configured to cause the processor to control the meal preparation unit to move to its open state before the meal is placed into the meal preparation unit, to move to its closed state after the meal is placed into the meal preparation unit, and to consecutively move to its open state again after the meal has been prepared by the meal preparation unit.

14. The system according to claim 1, wherein the processor is communicatively coupled to the meal preparation unit, and wherein the instructions are configured to cause the processor to control the meal preparation unit to prepare the meal according to a preparation technology to be used, a preparation time, a preparation temperature, a preparation intensity/power and a weight of the meal.

15. A method for providing meal order, preparation and delivery service, comprising:
at a first location:
pre-preparing a meal in a first preparation step; and
putting the meal in a container after pre-preparing the meal;
transferring the container to a second location remote from the first location;
at the second location:
providing a robotic system for autonomously preparing the meal, comprising a robotic device having a manipulator, including a holding means configured to hold the container;
placing the container in a meal storage and preservation unit configured to store and preserve the meal in the container;
receiving an order for the meal, and successively, in response to the order, by the robotic device:
removing the container from the meal storage and preservation unit;
placing the container into a meal preparation unit configured to prepare the meal;
removing the container from the meal preparation unit when the meal preparation unit has finished preparing; and
outputting the container containing the meal prepared with the meal preparation unit, and
delivering the dispensed container containing the meal from the second location to a customer that placed the order.

16. The method according to claim 15, further comprising:
by the robotic system, measuring a parameter indicative of a quality of meal preparation after the meal preparation unit has finished preparing the meal and before the step of outputting the container.

17. The method according to claim 16, further comprising, after the meal preparation unit has finished preparing the meal, by the robotic system, a least one of the following steps:
measuring a temperature of the meal using a thermal camera;
determining an integrity of the container, including a shape and/or a color of the container, using a photo camera and/or a vision camera; and
measuring a weight of the container using a scale.

18. The method according to claim 15, further comprising:
at the first location: applying a code to the container, the code containing information about the meal; and
at the second location: by the robotic system, reading the information from the code using a code reading means and storing the information in a memory,
wherein the information about the meal comprises a meal reference for identifying the meal inside the container, and wherein the step of reading the information from the code and storing the information in a memory comprises identifying the meal inside the container using the meal reference.

19. The method according to claim 15, wherein the information about the meal further comprises at least one of: ingredients of the meal, specifics about any pre-preparation of the meal, comprising a date of pre-preparation and/or identity information of a chef who pre-prepared the meal, a supplier of ingredients, a total weight of the meal before being prepared by the meal preparation unit, and a meal storage and preservation temperature.

20. The method according to claim 15, further comprising:
by the robotic system, registering positional information about the position of the container in the meal storage and preservation unit and storing the positional information in the memory.

21. The method according to claim 18, further comprising:
by the robotic system, registering positional information about the position of the container in the meal storage and preservation unit and storing the positional information in the memory, and linking the positional information to the meal reference.

22. The method according to claim 21, further comprising:
before the container is removed from the meal storage and preservation unit, locating, by the robotic system, the container in the meal storage and preservation unit on the basis of the meal reference and the positional information linked thereto.

23. The method according to claim 15, further comprising:
by the robotic system, locating the container in the meal storage and preservation unit using a depth camera mounted on the manipulator near the holding means of the robotic device.

24. The method according to claim 23, wherein the information about the meal is read from the code using the depth camera.
